(19) United States
(12) Patent Application Publication
(10) Pub. No.: US 2021/0208945 A1
(43) Pub. Date: Jul. 8, 2021

(54) INFORMATION PROCESSING APPARATUS, INFORMATION PROCESSING METHOD, AND COMPUTER READABLE MEDIUM

(71) Applicant: MITSUBISHI ELECTRIC CORPORATION, Tokyo (JP)

(72) Inventors: Kohei YAMAMOTO, Tokyo (JP); Takehisa MIZUGUCHI, Tokyo (JP); Masayuki KIRIMURA, Tokyo (JP); Tatsuya YAMADA, Tokyo (JP); Hiroki KONAKA, Tokyo (JP); Hideharu YASUTAKE, Tokyo (JP)

(73) Assignee: MITSUBISHI ELECTRIC CORPORATION, Tokyo (JP)

(21) Appl. No.: 17/211,356

(22) Filed: Mar. 24, 2021

Related U.S. Application Data
(63) Continuation of application No. PCT/JP2018/042387, filed on Nov. 16, 2018.

(51) Int. Cl. G06F 9/50; G06F 11/30; G06F 11/34

(52) U.S. Cl. CPC G06F 9/5055; G06F 11/3051; G06F 2209/508; G06F 11/3433; G06F 9/5038

(57) ABSTRACT

An information processing apparatus (100) has a ring buffer (113) and a save area (117). A log generation unit (108) generates a log of an application (107) in the ring buffer (113). A resource monitoring unit (109) monitors a current resource-usage amount for the application (107). A rule collation unit (111) determines whether the current resource-usage amount for the application (107) meets a log saving condition that is a condition for saving the log of the application (107). A log saving unit (112) saves, in the save area (117), the log in the ring buffer (113), if the current resource-usage amount for the application (107) is determined by the rule collation unit (111) to meet the log saving condition.

### CROSS REFERENCE TO RELATED APPLICATIONS

This application is a Continuation of PCT International Application No. PCT/JP2018/042387, filed on Nov. 16, 2018, all of which is hereby expressly incorporated by reference into the present application.

### TECHNICAL FIELD

The present invention relates to an information processing apparatus, an information processing method, and an information processing program.

### BACKGROUND ART

In a computer system, various failures or performance problems occur during operation. Thus, a failure and a performance problem are solved by recording operation-related information as log data and analyzing the log data.

The log data is output to a logging device through an interface with outside of the system. The log data may be written to an auxiliary storage device outside the system. Alternatively, the log data may be written to an auxiliary storage device inside the system.

With increase in the scale and speed of a system, a storage device may consume its capacity in a short period of time due to a huge amount of log data. Throughput in writing to the storage device may fall behind throughput in outputting a log. For these reasons, it is difficult to accumulate all log data that may be generated.

To cope with this, there is a technique for configuring a ring buffer in a main storage device and outputting a log to the ring buffer (Patent Literature 1). According to the technique, inputting by a user or occurrence of a failure in a system triggers a log in a ring buffer to be written to an auxiliary storage device. As a result, only useful log data is effectively accumulated.

### CITATION LIST

### Patent Literature

Patent Literature 1: JP 2013-206147

### SUMMARY OF INVENTION

### Technical Problem

If a ring buffer is configured in an internal main storage device in embedded equipment, the size of an area of the main storage device which can be used as the ring buffer is limited. For this reason, a log at a given time point remains in the ring buffer for short period of time. Thus, even if an intervention of a user at arbitrary timing is used as a trigger, there is a low probability of acquiring useful log data.

If occurrence of a system failure is used as a trigger for log data saving, useful log data is expected to be acquired. However, if a trigger cannot be clearly perceived from the outside such as occurrence of a performance problem which is not an obvious failure, a log cannot be acquired.

The present invention mainly aims at solving the above-described problems. Specifically, the present invention has as its major object to allow saving of a log even without occurrence of a specific event, such as failure occurrence.

### Solution to Problem

An information processing apparatus according to the present invention, that has a first storage area and a second storage area different from the first storage area and executes an application program, includes:

a log generation unit to generate a log of the application program in the first storage area;

a resource monitoring unit to monitor a current resource-usage amount for the application program;

a determination unit to determine whether the current resource-usage amount for the application program meets a log saving condition that is a condition for saving the log of the application program; and

a log saving unit to save, in the second storage area, the log of the application program in the first storage area, if the current resource-usage amount for the application program is determined by the determination unit to meet the log saving condition.

### Advantageous Effects of Invention

According to the present invention, it is possible to save a log even without occurrence of a specific event, such as failure occurrence.

### BRIEF DESCRIPTION OF DRAWINGS

FIG. 1 is a diagram illustrating an example of a hardware configuration of an information processing apparatus according to Embodiment 1.

FIG. 2 is a diagram illustrating an example of a functional configuration of the information processing apparatus according to Embodiment 1.

FIG. 3 is a diagram illustrating an example of a rule according to Embodiment 1.

FIG. 4 is a diagram illustrating an example of resource information according to Embodiment 1.

FIG. 5 is a diagram illustrating an example of state information according to Embodiment 1.

FIG. 6 is a flowchart illustrating an example of operation of the information processing apparatus according to Embodiment 1.

FIG. 7 is a flowchart illustrating an example of a rule collation process according to Embodiment 1.

FIG. 8 is a diagram illustrating an example of a functional configuration of an information processing apparatus according to Embodiment 2.

FIG. 9 is a flowchart illustrating an example of operation of the information processing apparatus according to Embodiment 2.

FIG. 10 is a flowchart illustrating an example of a rule collation process and a save list generation process according to Embodiment 2.

FIG. 11 is a diagram illustrating an example of a save rule according to Embodiment 2.

FIG. 12 is a diagram illustrating an example of the save rule according to Embodiment 2.

FIG. 13 is a diagram illustrating an example of the save rule according to Embodiment 2.

FIG. 14 is a diagram illustrating an example of the save rule according to Embodiment 2.

### DESCRIPTION OF EMBODIMENTS

Embodiments of the present invention will be described below with reference to the drawings. Parts denoted by identical reference characters represent identical or corresponding parts in the description of the embodiments and the drawings below.

### Embodiment 1

***Description of Configuration***

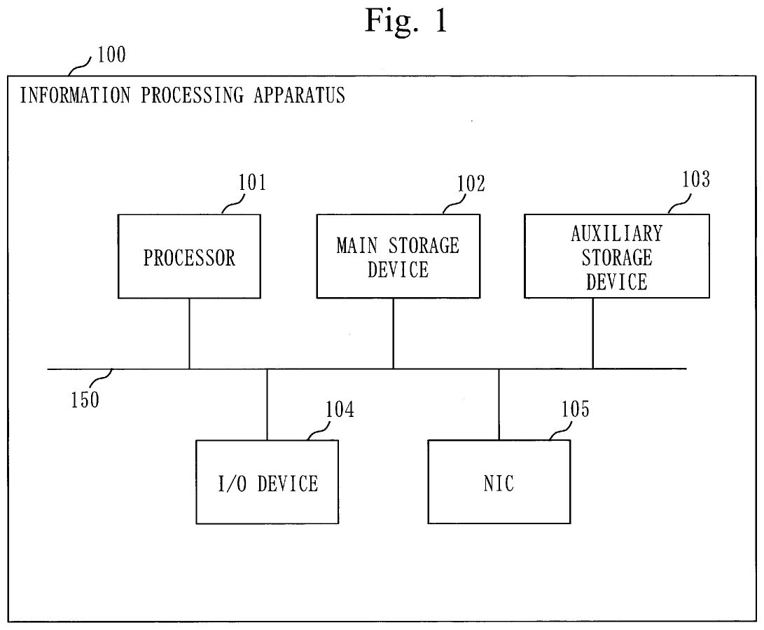

FIG. 1 illustrates an example of a hardware configuration of an information processing apparatus 100 according to Embodiment 1.

Note that operation performed by the information processing apparatus 100 corresponds to an information processing method and an information processing program.

The information processing apparatus 100 is a computer.

As illustrated in FIG. 1, the information processing apparatus 100 includes, as hardware, a processor 101, a main storage device 102, an auxiliary storage device 103, an I/O device 104, and a NIC (Network Interface Card) 105. The processor 101, the main storage device 102, the auxiliary storage device 103, the I/O device 104, and the NIC 105 are connected by a bus 150.

The processor 101 performs control of the information processing apparatus 100 and computation for the control. Specifically, the processor 101 executes a program.

The main storage device 102 is a volatile storage device which temporarily stores the program to be executed by the processor 101 and data to be handled by the program.

The auxiliary storage device 103 is a non-volatile storage device which stores the program and data to be read to the main storage device 102 and data which is written from the main storage device 102. The auxiliary storage device 103 is, for example, a storage device which is fixed to an apparatus, such as a hard disk drive or an eMMC (embedded Multi Media Card). Alternatively, the auxiliary storage device 103 may be a removable storage device which is connected via an interface, such as a USB (Universal Serial Bus) memory or an SD (registered trademark) card.

The I/O device 104 is an interface for connecting an input-output device, such as a display or a touch panel.

The NIC 105 is an interface for the information processing apparatus 100 to communicate with an external system.

Note that the I/O device 104 and the NIC 105 are merely illustrative and may be omitted and that the information processing apparatus 100 may be provided with devices other than the I/O device 104 and the NIC 105.

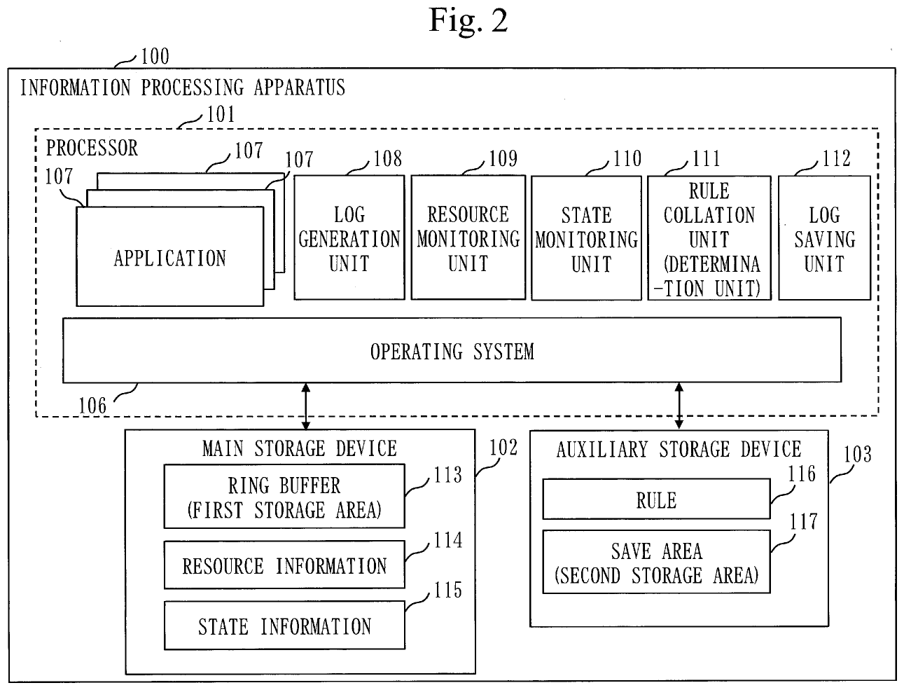

FIG. 2 illustrates an example of a functional configuration of the information processing apparatus 100.

An operating system 106 is operating in the information processing apparatus 100. An application program 107 (hereinafter simply referred to as the application 107) is operating on the operating system 106. There are a plurality of applications 107.

A log generation unit 108 generates a log of each application 107 in a ring buffer 113. The log generation unit 108 may also generate a log of the operating system 106 in the ring buffer 113.

The ring buffer 113 is an area in the main storage device 102. The ring buffer 113 corresponds to a first storage area.

A resource monitoring unit 109 monitors current resource-usage amounts for the applications 107. Then, the resource monitoring unit 109 stores a monitoring result as resource information 114 in the main storage device 102.

A state monitoring unit 110 monitors states of the applications 107. Then, the state monitoring unit 110 stores a monitoring result as state information 115 in the main storage device 102.

A rule collation unit 111 performs collation using the resource information 114 and the state information 115 in the main storage device 102 and a rule 116 in the auxiliary storage device 103.

Although the details will be described later, log saving conditions which are conditions for saving the logs of the applications 107 are defined in the rule 116.

The rule collation unit 111 determines whether the current resource-usage amount for each application 107 meets the log saving condition in the rule 116.

Note that the rule collation unit 111 corresponds to a determination unit. A process to be performed by the rule collation unit 111 corresponds to a determination process.

A log saving unit 112 outputs contents of the ring buffer 113 to a save area 117 in accordance with a collation result from the rule collation unit 111.

That is, if it is determined by the rule collation unit 111 that the current resource-usage amount for the application 107 meets the log saving condition, the log saving unit 112 saves, in a save area 117, the log of the application 107 in the ring buffer 113.

The save area 117 is an area in the auxiliary storage device 103. The save area 117 corresponds to a second storage area.

The log generation unit 108, the resource monitoring unit 109, the state monitoring unit 110, the rule collation unit 111, and the log saving unit 112 are realized by a program.

The program that realizes the log generation unit 108, the resource monitoring unit 109, the state monitoring unit 110, the rule collation unit 111, and the log saving unit 112 is stored in the auxiliary storage device 103 illustrated in FIG. 1. The program is loaded from the auxiliary storage device 103 into the main storage device 102. The processor 101 executes the program to perform operation of the log generation unit 108, the resource monitoring unit 109, the state monitoring unit 110, the rule collation unit 111, and the log saving unit 112.

FIG. 2 schematically represents a state where the program that realizes the log generation unit 108, the resource monitoring unit 109, the state monitoring unit 110, the rule collation unit 111, and the log saving unit 112 is executed together with the operating system 106 and the plurality of applications 107 by the processor 101.

The resource information 114 and the state information 115 are pieces of information which are recorded by the resource monitoring unit 109 and the state monitoring unit 110, respectively, as described earlier.

The rule 116 is used by the rule collation unit 111, as described earlier, and is defined and stored in advance in the auxiliary storage device 103 by a user.

Resources are computer resources to be handled by the information processing apparatus 100. The resources are, for example, various elements, such as a processor, a main storage device, an auxiliary storage device, an I/O, and a network. Elements other than these may be handled as resources.

The resource-usage amount may be a total usage amount in a measurement period or an average usage amount per unit time, as long as the resource-usage amount is a common value for each resource. The resource-usage amount may be a statistical usage rate obtained through sampling or any other value that can be measured and compared.

States are activation, standby, normal operation, and the like of the application 107. For example, if the application 107 is an audio reproduction application, activation, standby, in-reproduction, and the like of the audio reproduction application are conceivable. States, however, are not limited to these.

As a state monitoring method, a method in which each application 107 notifies the state monitoring unit 110 of a state via an API (Application Programming Interface) is conceivable. A method in which the state monitoring unit 110 determines a state from a message output by each application 107 may be acceptable as the state monitoring method. Any other method may be acceptable, as long as a state can be uniquely determined.

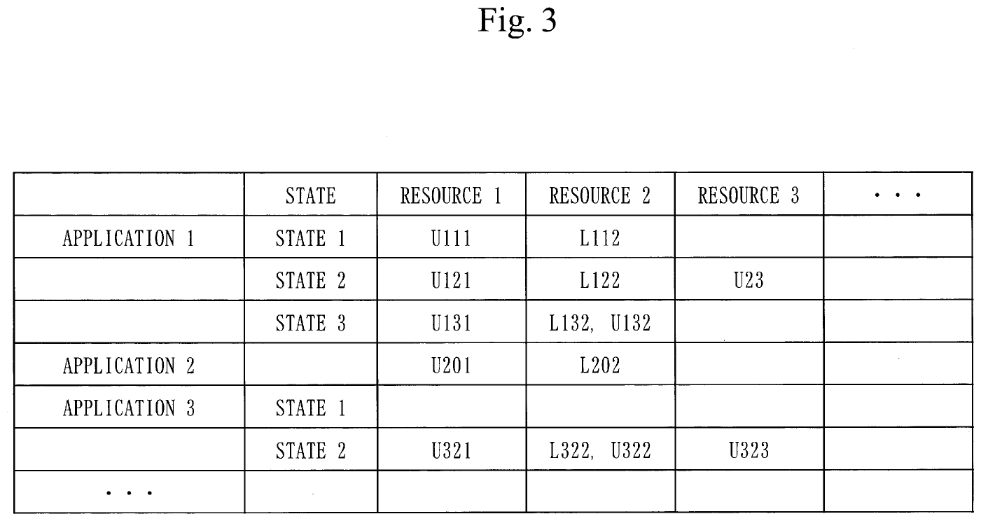

FIG. 3 illustrates an example of the rule 116. Note that the rule 116 is not limited to the format illustrated in FIG. 3.

In FIG. 3, for example, states 1, 2, and 3 are defined for application 1. Note that a state may not be defined, as in the case of application 2.

In the rule 116, a resource-usage amount threshold is defined for an application or a combination of an application and a state. “U” in FIG. 3 represents an upper limit value while “L” represents a lower limit value.

For example, for a combination of application 1 and state 1, an upper limit value of U111 is defined for resource 1. That is, if application 1 is in state 1 and a resource-usage amount of resource 1 for application 1 exceeds U111, a log of application 1 is saved in the save area 117. For application 2, an upper limit value of U201 is defined for resource 1. That is, if a resource-usage amount of resource 1 for application 2 exceeds U201, a log of application 2 is saved in the save area 117, regardless of a state of application 2.

A resource-usage amount threshold for each application or a resource-usage amount threshold for each combination of an application and a state indicated in the rule 116 as described above corresponds to a log saving condition.

Note that a resource-usage amount threshold need not be defined for each of all combinations of applications and states in the rule 116. For example, a resource-usage amount threshold of resource 3 is not defined for a combination of application 1 and state 1. Both an upper limit value and a lower limit value may be defined, like L132 and U132 of resource 2 for a combination of application 1 and state 3.

Even in a case where no state is defined, as in the case of application 2, only a resource-usage amount threshold may be defined. As in the case of application 3, a resource-usage amount may not be defined for state 1, and a resource-usage amount threshold of U321, resource-usage amount thresholds of L322 and U322, and a resource-usage amount threshold of U323 may be respectively defined for resources 1, 2, and 3 for state 2.

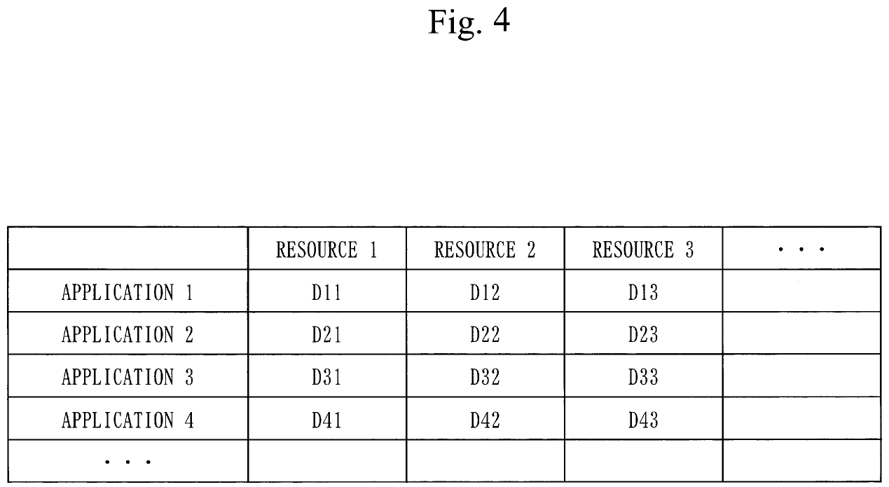

FIG. 4 illustrates an example of the resource information 114. Note that a method for expressing the resource information 114 is not limited to the one illustrated in FIG. 4.

The resource information 114 indicates a monitoring result of resource-usage amounts by the resource monitoring unit 109. The resource information 114 has one value for a combination of an application and a resource.

FIG. 4 indicates, for example, that a current resource-usage amount of resource 1 for application 1 is D11, a current resource-usage amount of resource 2 is D12, and a current resource-usage amount of resource 3 is D13.

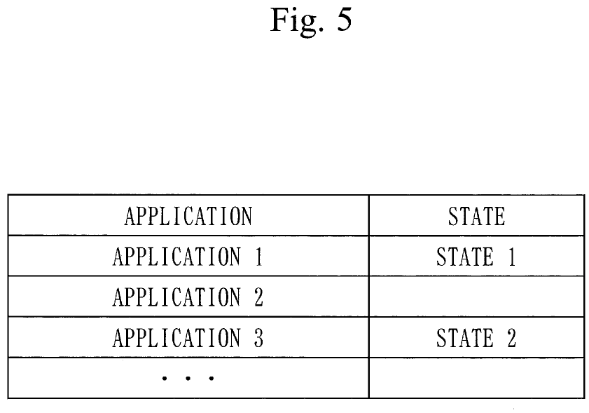

FIG. 5 illustrates an example of the state information 115. Note that a method for expressing the state information 115 is not limited to the one illustrated in FIG. 5.

The state information 115 is composed of sets of applications and states.

FIG. 5 indicates that application 1 is currently in state 1 and application 3 is currently in state 2. Note that there may be no state, as in the case of application 2.

***Description of Operation***

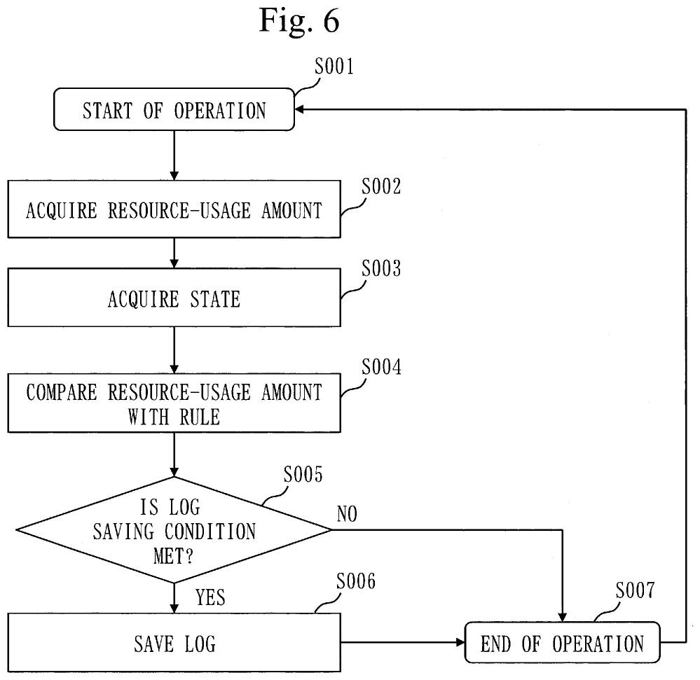

An example of operation of the information processing apparatus 100 according to Embodiment 1 will be described with reference to the flowchart in FIG. 6.

Note that although the information processing apparatus 100 obtains effects by repeating a series of operations illustrated in FIG. 6, an arbitrary waiting time period may be provided each time the information processing apparatus 100 ends the series of operations.

After the information processing apparatus 100 starts operation in step S001, the resource monitoring unit 109 acquires a resource-usage amount for each application 107 in step S002.

The resource monitoring unit 109 stores the acquired resource-usage amounts as the resource information 114 in the main storage device 102.

Subsequently, the state monitoring unit 110 acquires a state of each application 107 in step S003.

The state monitoring unit 110 stores the acquired states as the state information 115 in the main storage device 102.

In step S004, the rule collation unit 111 collates the resource information 114 and the state information 115 in the main storage device 102 with the rule 116 in the auxiliary storage device 103.

The details of the rule collation process in step S004 will be described later.

As a result of the collation in step S004, if the log saving condition is met, the rule collation unit 111 notifies the log saving unit 112 that the log saving condition is met.

The log saving unit 112 saves, in the save area 117 in the auxiliary storage device 103, a log present in the ring buffer 113 in the main storage device 102 in step S006 and ends the process in FIG. 6 (step S007).

As the result of the collation by the rule collation unit 111, if the log saving condition is not met, the process in FIG. 6 ends (step S007).

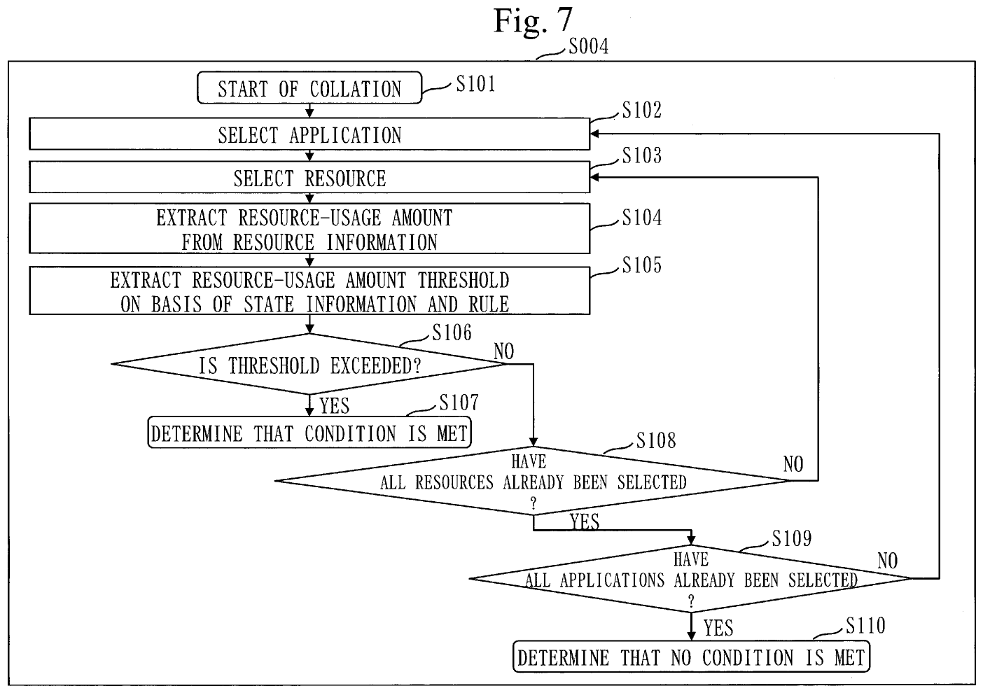

The details of the rule collation process in step S004 will next be described with reference to FIG. 7.

First, when the rule collation process starts in step S101, the rule collation unit 111 selects one application in step S102.

Next, the rule collation unit 111 selects one resource in step S103.

Next, in step S104, the rule collation unit 111 extracts for the currently selected application, a resource-usage amount of a resource which is currently selected, from the resource information 114.

Next, in step S105, the rule collation unit 111 extracts a resource-usage amount threshold which is currently selected, using the state information 115 and the rule 116.

The rule collation unit 111 first extracts a current state of the currently selected application from the state information 115. The rule collation unit 111 then extracts for the current state of the currently selected application, the resource-usage amount threshold currently selected, from the rule 116.

Next, the rule collation unit 111 compares the resource-usage amount acquired in step S104 with the threshold extracted in step S105. If the resource-usage amount exceeds the threshold (a lower limit or an upper limit) (YES in step S106), the rule collation unit 111 determines in step S107 that a log saving condition is met. In this case, step S005 in FIG. 6 goes to YES.

On the other hand, if the resource-usage amount does not exceed the threshold (the lower limit or the upper limit) (NO in step S106), the rule collation unit 111 checks in step S108 whether all resources have already been selected for the currently selected application.

If there is any resource that has not been selected yet (NO in step S108), the rule collation unit 111 selects the resource that has not been selected yet in step S103 to perform processes in step S104 and subsequent steps.

On the other hand, if all the resources have already been selected for the currently selected application (YES in step S108), it is checked in step S109 whether there is any application that has not been selected yet.

If there is any application that has not been selected yet (NO in step S109), the rule collation unit 111 selects the application that has not been selected yet in step S102 to perform processes in step S103 and subsequent steps.

If all the resources for all the applications have already been selected without any rule deviation (YES in step S109), the rule collation unit 111 determines that no log saving condition is met (step S110). In this case, step S005 in FIG. 6 goes to NO.

As described above, if there is any resource, a threshold for which is exceeded, the rule collation unit 111 determines that a log saving condition is met. In this case, all logs in the ring buffer 113 are saved in the save area 117.

On the other hand, only if there is no resource, a threshold for which is exceeded, the rule collation unit 111 determines that no log saving condition is met.

A part of the rule collation process will next be specifically described with reference to FIGS. 3, 4, and 5.

Assume that the rule collation unit 111 first selects application 1 and then selects resource 1. The rule collation unit 111 extracts the resource-usage amount of D11 in FIG. 4 on a basis of currently selected application 1 and currently selected resource 1.

The rule collation unit 111 then extracts state 1 that is a current state of application 1 from FIG. 5.

The rule collation unit 111 then extracts the upper limit value of U111 that is a threshold for application 1, state 1, and resource 1 from FIG. 3.

The rule collation unit 111 then compares the resource-usage amount of D11 with the upper limit value of U111. If D11≤U111, there is no excess over the threshold. If D11>U111, there is an excess over the threshold.

If there is no excess over the threshold for application 1 and resource 1, the rule collation unit 111 then selects application 1 and resource 2 and continues collation.

### Description of Advantageous Effects of Embodiment

As has been described above, in the present embodiment, when a resource-usage amount for an application deviates from a rule which is defined in advance, a log is saved in an auxiliary storage device.

For this reason, according to the present embodiment, a log can be saved even without occurrence of a specific event, such as failure occurrence. That is, according to the present embodiment, it is possible to save the log even in a previously-difficult case of, for example, a performance problem.

### Embodiment 2

Embodiment 1 above has described an example with a single ring buffer which stores logs.

The present embodiment will describe an example where a plurality of ring buffers are prepared.

If there are a plurality of types of logs, such as a message of an operating system, an event of the operating system, and a message of an application, a plurality of ring buffers may be prepared. In this case, a ring buffer as a storage destination for a log changes depending on the type of the log. In such a case where a plurality of ring buffers are prepared, a ring buffer being an object to be saved needs to be selected.

***Description of Configuration***

A hardware configuration of an information processing apparatus 100 according to the present embodiment is as illustrated in FIG. 1.

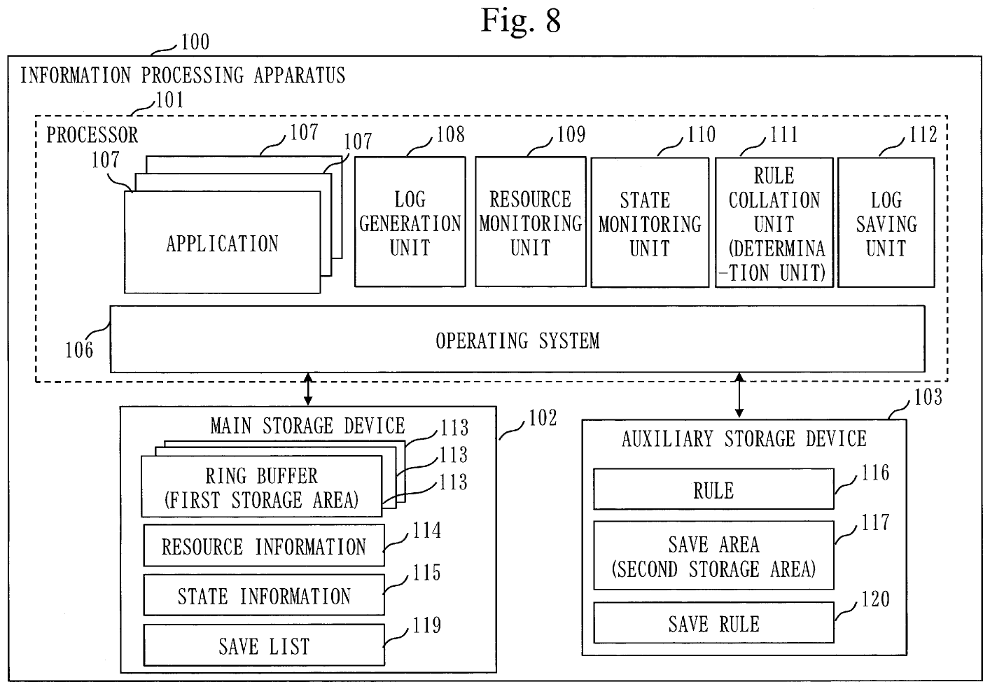

FIG. 8 illustrates an example of a functional configuration of the information processing apparatus 100 according to the present embodiment.

Only one ring buffer 113 is present in FIG. 2 according to Embodiment 1. In contrast, a plurality of ring buffers 113 are present in FIG. 8. A save list 119 is added to a main storage device 102 in FIG. 8. A save rule 120 is further added to an auxiliary storage device 103 in FIG. 8.

Each of the plurality of ring buffers 113 in FIG. 8 corresponds to a first storage area.

Since elements other than the above-described ones are the same as those illustrated in FIG. 2, a description thereof will be omitted.

***Description of Operation***

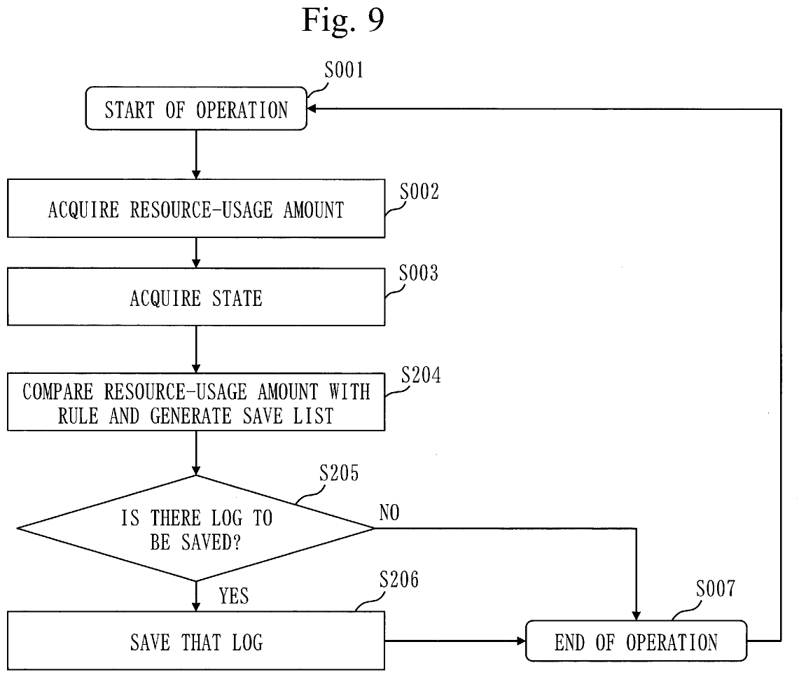

An example of operation of the information processing apparatus 100 according to Embodiment 2 will next be described with reference to FIG. 9.

Since operations in steps S001 to S003 in FIG. 9 are identical to those in steps S001 to S003 in FIG. 6 according to Embodiment 1, a description thereof will be omitted.

The rule collation unit 111 collates a resource-usage amount with a rule, as in step S004 in FIG. 6, and further generates the save list 119 in step S204. The rule collation unit 111 also notifies a log saving unit 112 of the save list 119.

If the log saving unit 112 is notified of the save list 119, that is, there is a log to be saved (YES in step S205), the log saving unit 112 saves a log in a corresponding ring buffer in a save area 117 in the auxiliary storage device 103 on a basis of the save list 119 in step S206.

On the other hand, if notification of the save list 119 is not given, that is, there is no log to be saved (NO in step S205), the operation ends (step S007).

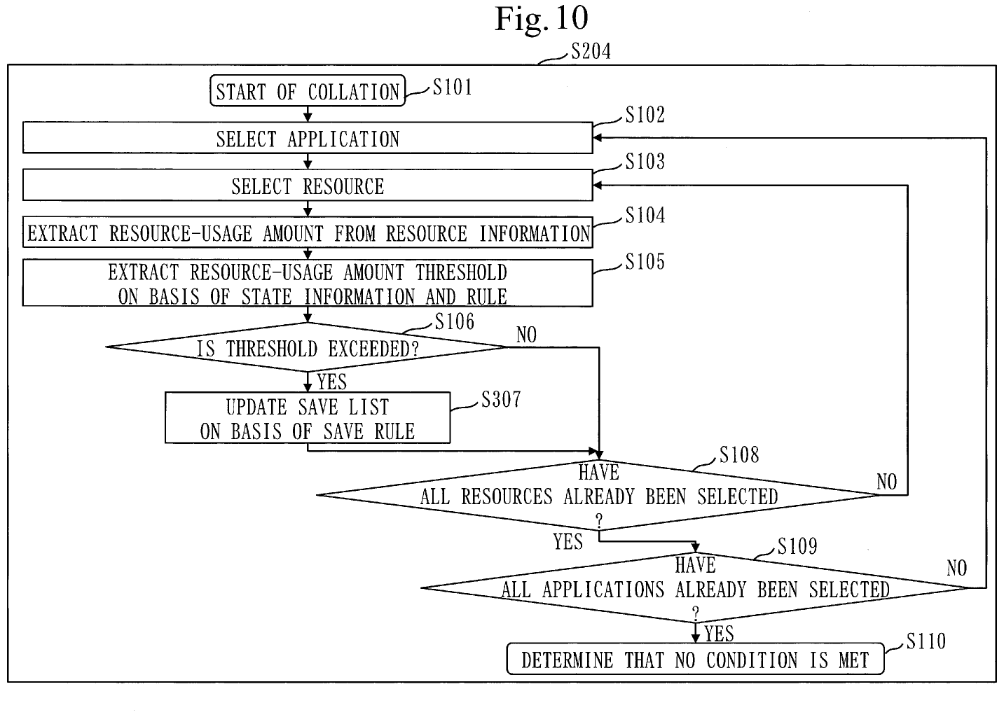

The details of the rule collation process and the save list generation process in step S204 will next be described with reference to FIG. 10.

First, the rule collation unit 111 initializes and empties the save list 119 at the start of the collation (step S101).

Since operations in steps S102 to S106 in FIG. 10 are identical to those in steps S102 to S106 in FIG. 7 in Embodiment 1, a description thereof will be omitted.

If a resource-usage amount exceeds a threshold in step S106 (YES in step S106), the rule collation unit 111 selects a ring buffer to be saved on a basis of the save rule 120 and updates the save list 119 in step S307.

Logs of all applications 107 in a ring buffer described in the save list 119 are objects to be saved in the save area 117. For example, assume that logs of application 1, application 2, and application 3 are generated in ring buffer 1. Even if application 1 matches the save rule 120 and ring buffer 1 is selected as an object of saving, all the logs of application 1, application 2, and application 3 in ring buffer 1 are saved in the save area 117.

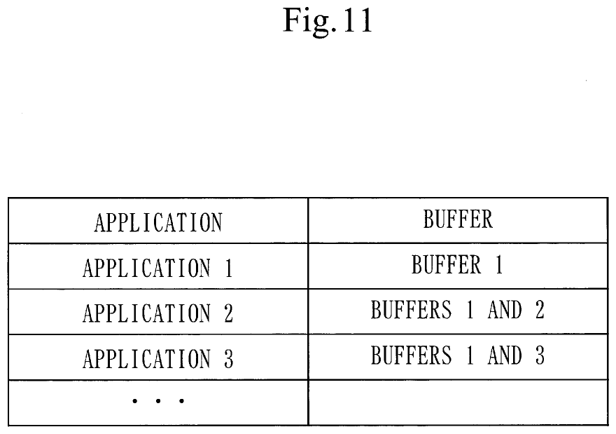

Examples of the save rule 120 are illustrated in FIGS. 11, 12, 13, and 14.

FIG. 11 illustrates an example of the save rule 120 that selects a ring buffer to be saved on a basis of an application. If the save rule 120 in FIG. 11 is used, a ring buffer being an object of saving is selected on a basis of an application which is selected when it is determined in step S106 that a resource-usage amount exceeds a threshold.

For example, if a resource-usage amount for application 1 exceeds a threshold in a rule 116, the rule collation unit 111 selects ring buffer 1 corresponding to application 1 as an object of saving on a basis of the save rule 120 in FIG. 11. The rule collation unit 111 then adds ring buffer 1 to the save list 119.

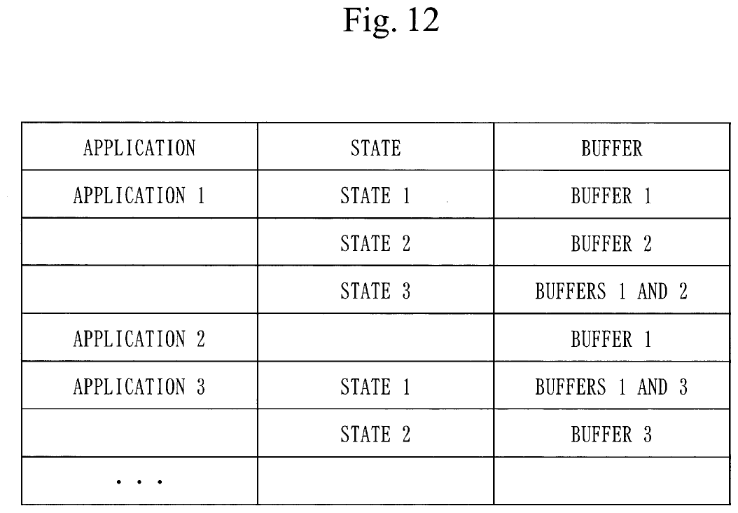

FIG. 12 illustrates an example of the save rule 120 that selects a ring buffer to be saved on a basis of a combination of an application and a state. If the save rule 120 in FIG. 12 is used, a ring buffer being an object of saving is selected on a basis of a combination of an application and a state which is selected when it is determined in step S106 that a resource-usage amount exceeds a threshold.

For example, if a resource-usage amount for application 1 exceeds a threshold in the rule 116 when application 1 is in state 1, the rule collation unit 111 selects ring buffer 1 corresponding to the combination of application 1 and state 1 as an object of saving on a basis of the save rule 120 in FIG. 12. The rule collation unit 111 then adds ring buffer 1 to the save list 119.

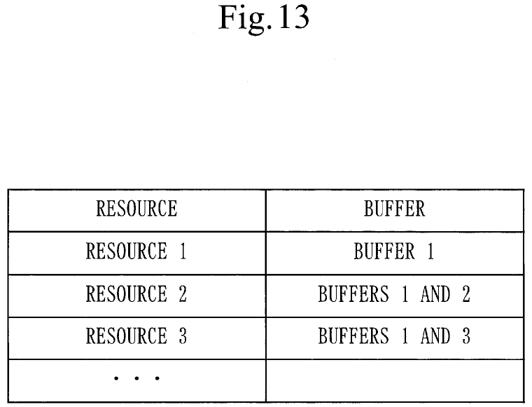

FIG. 13 illustrates an example of the save rule 120 that selects a ring buffer to be saved on a basis of a resource. If the save rule 120 in FIG. 13 is used, a ring buffer being an object of saving is selected on a basis of a resource, a resource-usage amount of which is determined in step S106 to exceed a threshold.

For example, if a resource-usage amount of resource 1 exceeds a threshold in the rule 116, the rule collation unit 111 selects ring buffer 1 corresponding to resource 1 as an object of saving on a basis of the save rule 120 in FIG. 13. The rule collation unit 111 then adds ring buffer 1 to the save list 119.

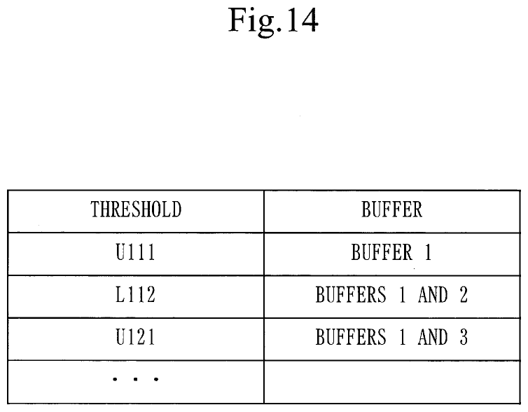

FIG. 14 illustrates an example of the save rule 120 that selects a ring buffer to be saved on a basis of a resource-usage amount threshold. If the save rule 120 in FIG. 14 is used, a ring buffer being an object of saving is selected on a basis of a threshold which is determined in step S106 to be exceeded by a resource-usage amount.

For example, if a resource-usage amount of resource 1 exceeds a threshold of U111 in the rule 116, the rule collation unit 111 selects ring buffer 1 corresponding to the threshold of U111 as an object of saving on a basis of the save rule 120 in FIG. 14. The rule collation unit 111 then adds ring buffer 1 to the save list 119.

Note that the save rule 120 is not limited to the examples in FIGS. 11, 12, 13, and 14. Any type of save rule 120 may be acceptable as long as a ring buffer to be saved can be uniquely selected.

Referring back to the flowchart in FIG. 10, after updating the save list 119 in step S307, the rule collation unit 111 repeats steps S101 to S106 and step S307 until processing is completed for all resources and all applications.

### Description of Advantageous Effects of Embodiment

As has been described above, in the present embodiment, when a resource-usage amount for an application deviates from a rule which is defined in advance, a log related to the deviated rule or to a deviated situation is saved in an auxiliary storage device. Thereby, it is possible to preferentially save a particularly useful log, in a previously-difficult case of, for example, a performance problem.

The embodiments of the present invention have been described above. These two embodiments may be combined and carried out.

Alternatively, one of these two embodiments may be partially carried out.

Alternatively, these two embodiments may be partially combined and carried out.

Note that the present invention is not limited to the embodiments and that the embodiments can be variously changed, as needed.

***Description of Hardware Configuration***

Finally, a supplemental explanation of the hardware configuration of the information processing apparatus 100 will be given.

The processor 101 illustrated in FIG. 1 is an IC (Integrated Circuit) which performs processing.

The processor 101 is a CPU (Central Processing Unit), a DSP (Digital Signal Processor), or the like.

The main storage device 102 illustrated in FIG. 1 is a RAM (Random Access Memory).

The auxiliary storage device 103 illustrated in FIG. 1 is a ROM (Read Only Memory), a flash memory, an HDD (Hard Disk Drive), or the like.

The processor 101 executes a program which realizes functions of the log generation unit 108, the resource monitoring unit 109, the state monitoring unit 110, the rule collation unit 111, and the log saving unit 112 while executing at least a part of the operating system 106.

The processor 101 executes the operating system 106, thereby performing task management, memory management, file management, communication control, and the like.

At least any of information, data, signal values, and variable values indicating results of processing by the log generation unit 108, the resource monitoring unit 109, the state monitoring unit 110, the rule collation unit 111, and the log saving unit 112 is stored in at least any of the main storage device 102, the auxiliary storage device 103, and a register and a cache memory inside the processor 101.

The program that realizes the functions of the log generation unit 108, the resource monitoring unit 109, the state monitoring unit 110, the rule collation unit 111, and the log saving unit 112 may be stored in a portable recording medium, such as a magnetic disk, a flexible disk, an optical disc, a compact disc, a Blu-ray (registered trademark) Disc, or a DVD.

The “unit” in each of the log generation unit 108, the resource monitoring unit 109, the state monitoring unit 110, the rule collation unit 111, and the log saving unit 112 may be replaced with “circuit”, “step”, “procedure”, or “process”.

The information processing apparatus 100 may be realized by a processing circuit. The processing circuit is, for example, a logic IC (Integrated Circuit), a GA (Gate Array), an ASIC (Application Specific Integrated Circuit), or an FPGA (Field-Programmable Gate Array).

Note that the superordinate concept of the processor and the processing circuit is referred to as “processing circuitry” in the present specification.

That is, the processor and the processing circuit are specific examples of “processing circuitry”.

### REFERENCE SIGNS LIST

100: information processing apparatus, 101: processor, 102: main storage device, 103: auxiliary storage device, 104: I/O device, 105: NIC, 106: operating system, 07: application, 108: log generation unit, 109: resource monitoring unit, 110: state monitoring unit, 111: rule collation unit, 112: log saving unit, 113: ring buffer, 114: resource information, 115: state information, 116: rule, 117: save area, 119: save list, 120: save rule

1. An information processing apparatus that has a first storage area and a second storage area different from the first storage area and executes an application program, the information processing apparatus comprising:
processing circuitry:
to generate a log of the application program in the first storage area;
to monitor a current resource-usage amount for the application program;
to monitor a state of the application program;
to determine whether the current resource-usage amount for the application program meets a log saving condition for a current state of the application program among log saving conditions each of which is a condition for saving the log of the application program and is provided for each state among a plurality of states of the application program; and
to save, in the second storage area, the log of the application program in the first storage area, if the current resource-usage amount for the application program is determined to meet the log saving condition for the current state of the application program.

2. The information processing apparatus according to claim 1, wherein
the processing circuitry
monitors a current resource-usage amount of each of a plurality of resources that are used by the application program,
determines, for each of the plurality of resources, whether a current resource-usage amount for the current state of the application program meets a log saving condition which is provided for each state and each resource of the application program, and
saves, in the second storage area, the log of the application program in the first area, if the current resource-usage amount of any resource in the plurality of resources is determined to meet the log saving condition for the resource for the current state of the application program.

3. The information processing apparatus according to claim 1, wherein
a plurality of application programs are executed in the information processing apparatus, and wherein
the processing circuitry
generates logs of the plurality of application programs in the first storage area,
monitors current resource-usage amounts for the plurality of application programs,
determines, for each of the application programs, whether the current resource-usage amount meets a log saving condition for each application program, and
saves, in the second storage area, the logs of the plurality of application programs in the first storage area, if the current resource-usage amount for any application program in the plurality of application programs is determined to meet the log saving condition for the application program.

4. An information processing apparatus that has a plurality of first storage areas and a second storage area different from the plurality of first storage areas and executes a plurality of application programs, the information processing apparatus comprising:
processing circuitry:
to generate, for each of the plurality of application programs, logs in one or more first storage areas among the plurality of first storage areas;
to monitor current resource-usage amounts for the plurality of application programs;
to determine, for each of the plurality of application programs, whether the current resource-usage amount meets a log saving condition which is a condition for saving the log and is provided for each of the plurality of application programs; and
to select, if the current resource-usage amount for any application program in the plurality of application programs is determined to meet the log saving condition for the application program, a first storage area being an object of log saving from among the one or more first storage areas for the application program, and save, in the second storage area, the log in the selected first storage area.

5. The information processing apparatus according to claim 4, wherein
the processing circuitry
monitors states of the plurality of application programs,
determines, for each of the application programs, whether the current resource-usage amount meets a log saving condition for the current state among log saving conditions each of which is provided for each of the application programs and for each state among a plurality of states, and
selects, if the current resource-usage amount for any application program in the plurality of application programs is determined to meet the log saving condition for the current state of the application program, a first storage area being an object of log saving from among the one or more first storage areas for the application program, and saves, in the second storage area, the log in the selected first storage area.

6. The information processing apparatus according to claim 4, wherein
the processing circuitry
generates, for each of the plurality of application programs, logs in one or more first storage areas among the plurality of first storage areas,
monitors, for each of the plurality of application programs, a current resource-usage amount of each of a plurality of resources that are used by the application programs,
determines, for each of the application programs and each of the resources, whether the current resource-usage amount meets a log saving condition which is provided for each application program and each resource, and
selects a first storage area being an object of log saving from among the one or more first storage areas for the application program, and saves, in the second storage area, the log in the selected first storage area, if the current resource-usage amount of any resource for any application program is determined to meet the log saving condition of the resource for the application program.

7. An information processing method performed by a computer that has a first storage area and a second storage area different from the first storage area and executes an application program, the information processing method comprising:
generating a log of the application program in the first storage area;
monitoring a current resource-usage amount for the application program;
monitoring a state of the application program;
determining whether the current resource-usage amount for the application program meets a log saving condition for a current state of the application program among log saving conditions each of which is a condition for saving the log of the application program and is provided for each state among a plurality of states of the application program; and
saving in the second storage area, the log of the application program in the first storage area, if the current resource-usage amount for the application program is determined to meet the log saving condition for the current state of the application program.

8. A non-transitory computer readable medium storing an information processing program that causes, a computer that has a first storage area and a second storage area different from the first storage area and executes an application program, to execute the information processing method according to claim 7.
